(19) United States
(12) Patent Application Publication
(10) Pub. No.: US 2002/0007263 A1
(43) Pub. Date: Jan. 17, 2002

(54) Apparatus for supporting microprocessor development system

(76) Inventors: Jong-Hong Bae, Kyoungki-do (KR); Se-Jin Yoo, Kyoungki-do (KR)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/870,253

(22) Filed: May 30, 2001

(30) Foreign Application Priority Data
May 31, 2000 (KR) 2000-29682

(51) Int. Cl. G06F 9/455

(52) U.S. Cl. 703/23

(57) ABSTRACT

An apparatus is provided for effectively supporting a microprocessor development system by using a single chip without designing an evaluation chip. The apparatus includes a microprocessor control unit (MCU) chip for communicating data and control signals with respect to a target board through a multiplicity of ports, and for providing RAM addresses, a special function register (SFR) address and data. The apparatus also includes an input/output block for receiving the addresses and the data through the ports, for providing the received data to the target board, and for controlling data to be inputted in the MCU chip.

### FIELD OF THE INVENTION

The present invention relates to a semiconductor integrated circuit; and, more particularly, to an apparatus for supporting a microprocessor development system (MDS) without the use of an evaluation chip (Eva-chip) having additional pins.

### DESCRIPTION OF THE PRIOR ART

In general, a microprocessor development system (which is referred to as MDS hereinafter) used in developing a system associated with a micro-controller unit (which is referred to as MCU hereinafter) requires an additional evaluation chip (Eva-chip) adapted for a development plan. The Eva-chip allows a program to be incorporated in ROM of the MCU to be fetched from an external ROM or RAM, and permits a developer to grasp an internal status of the MCU, to thereby easily facilitate debugging processes.

FIG. 1 is a block diagram depicting a conventional MDS supporting circuit using an Eva-chip.

Referring to FIG. 1, the conventional MDS supporting circuit includes an MCU Eva-chip 110. A target system 100 is connected to the MCU Eva-chip 110 through a plurality of ports and a MDS 120 is also connected to the MCU Eva-chip 110. As a result, the target system 100 is controlled by the MCU Eva-chip 110 based on program codes in the MDS 120. The MDS 120 includes a virtual ROM 121, a RAM block 122, a special function register (which is referred to as “SFR” hereinafter) block 123 and a clock controller 124.

The virtual ROM stores the program codes for the target system 100 and is actually implemented by a RAM memory device which functions as a ROM to operate the target system 100 through the MCU Eva-chip 110 so that such a RAM memory device is called a virtual ROM in this invention. A host interface makes it possible for a program developer to check up the operation of the target system 100 through the virtual ROM 121, the RAM block 122 and the SFR block 123.

The Eva chip 110 communicates with the target system 100 to establish environments required in the target system 100 though a plurality of ports, this environment establishment is achieved by fetching program codes from the virtual ROM 121 and the Eva chip 110 also generates addresses and data for the MDS 120. As shown in FIG. 1, the Eva chip 110 has a plurality of pins for the RAM block 122, i.e., 1 numbers of pins for address signals, p numbers of pins for data transmission and a RAM control pin. As for the SFR block 123, the Eva chip 110 has a plurality of pins, i.e., m numbers of pins for address signals, q numbers of pins for data transmission and a SFR control pin. The Eva chip 10 provides an internal clock to the clock controller 124 and the clock controller 12 receiving the internal clock controls the virtual ROM 121, the RAM block 122 and the SFR block 123.

The conventional MDS supporting circuit requires a multiplicity of additional pins for interface with the MDS 120 in addition to the port signals and the control signals. Further, after the system development, an additional chip other than the Eva-chip should be developed. Accordingly, the use of such Eva-chip involves a prolonged development period and an increased cost. Therefore, what is need is an apparatus for effectively supporting functions needed in the microprocessor development system by using a single chip, without designing the Eva-chip.

### BRIEF DESCRIPTION OF THE DRAWINGS

The following description of the preferred embodiments is given in conjunction with the accompanying drawings, in which:

FIG. 1 is a block diagram depicting a conventional MDS supporting circuit using an Eva-chip;

FIG. 2 illustrates, in timing diagram form, a preferred data write process in an internal RAM performed in accordance with the teachings of the present invention;

FIG. 3 shows, in timing diagram form, a preferred data write process in the special function register (SFR) performed in accordance with the teachings of the present invention;

FIG. 4 denotes, in timing diagram form, a preferred data write process in input/output ports performed in accordance with the teachings of the present invention;

FIG. 5 is a detailed block diagram of an MDS supporting circuit constructed in accordance with the teachings of the present invention;

FIG. 6 is a block diagram depicting an exemplary configuration of a preferred MCU I/O port constructed in accordance with the teachings of the present invention; and

FIG. 7 is a detailed block diagram of the I/O block of FIG. 5.

### DETAILED DESCRIPTION OF THE PREFERRED EMBODIMENTS

The apparatus described below is provided for effectively supporting a microprocessor development system (MDS). The illustrated apparatus comprises an MCU block for communicating port data and control signals with respect to a target board to be developed by a user through a multiplicity of ports, and for providing addresses, data and a multiplicity of control signals to an MDS through another multiplicity of ports. The apparatus also includes the MDS for receiving the addresses, the data, and the control signals provided thereto from the MCU block and for accessing data stored in a register therein to develop a program.

Further, the disclosed apparatus allows external I/O ports to timely select to thereby implement an internal bus to port (IB2P) used in outputting external ROM code fetches and MCU internal data, without using an additional MDS supporting pin.

In general, the MCU performs one write process for a memory region during one instruction cycle and therefore allows I/O ports to be timely selected.

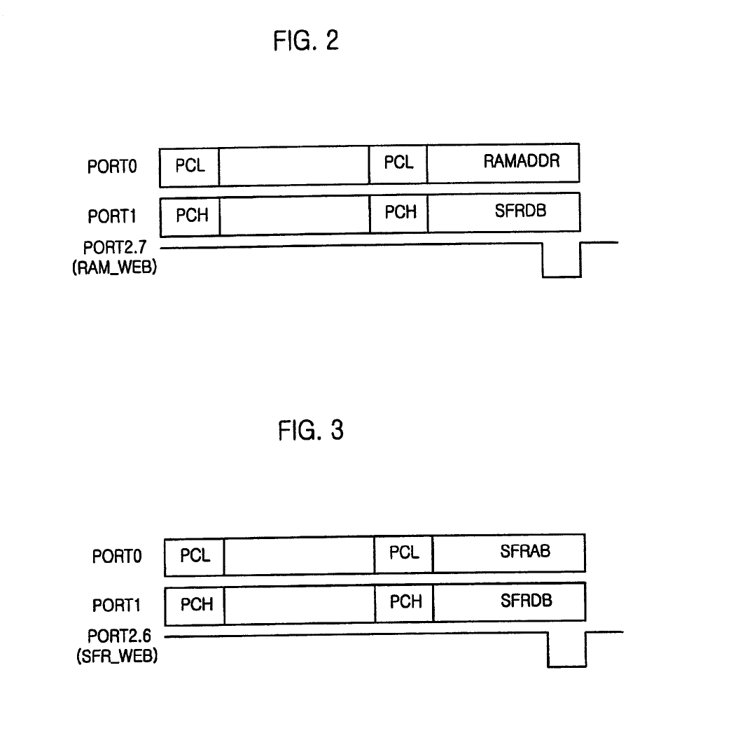

FIG. 2 illustrates, in timing diagram form, a preferred data write process in an internal RAM. Referring to FIG. 2, in Port PORT0, a program code low address PCL is assigned followed by a RAM address RAMADDR. In Port PORT1, a program code high address PCH is assigned followed by a RAM data RAMD. If a logic low pulse signal is generated at the 7th bit in Port 2(i.e., PORT 2.7), the RAMADDR and the RAMD are simultaneously fetched to write.

FIG. 3 shows, in timing diagram form, a preferred data write process in the special function register (SFR). Referring to FIG. 3, in Port PORT0, a program code low address PCL is assigned followed by an SFR address SFRAB. In Port PORT1, a program code high address PCH is assigned followed by SFR data SFRDB. If a logic low pulse signal is generated at 6th bit in Port 2 (i.e., PORT 2.6), the SFRAB and the SFRDB are simultaneously fetched to write.

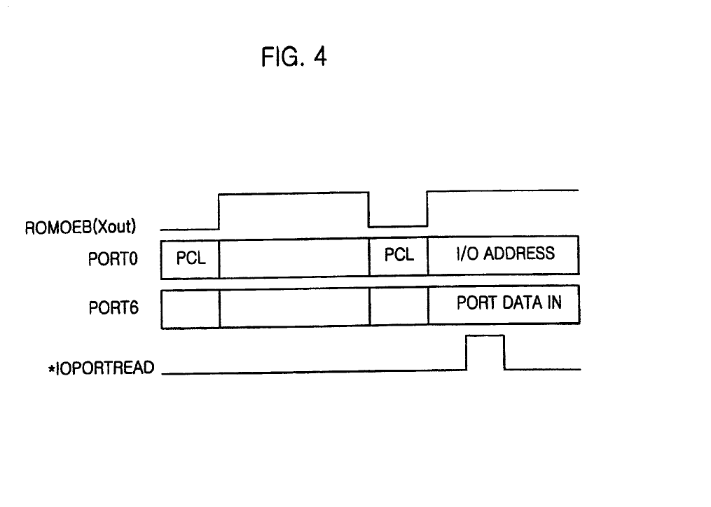

FIG. 4 denotes, in timing diagram form, a preferred data write process in input/output ports. Referring to FIG. 4, when a ROM output active signal ROMOEB is activated into a logic low, a program code low address PCL is assigned in Port PORT0; and, if an I/O port read signal IOPortRead is activated into a logic high, an I/O address is fetched in Port 0 and a port input data PortDataIn is fetched in Port PORT6, thereby allowing the I/O address and the data PortDataIn to be concurrently written.

As can be seen from FIGS. 2 to 4, the timing at which the program code is fetched and decoded in the ROM and the decoded data is written in the RAM or the SFR region is misaligned with the timing at which the input/output data is processed. This misalignment allows data to be timely selected for use at the I/O port, and makes it possible to easily develop the system by using only a single chip without the Eva-chip.

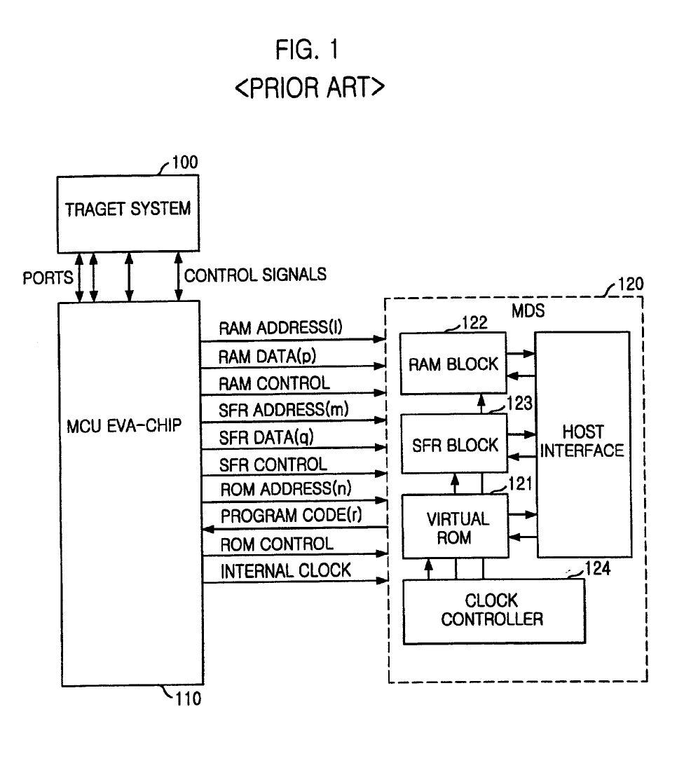

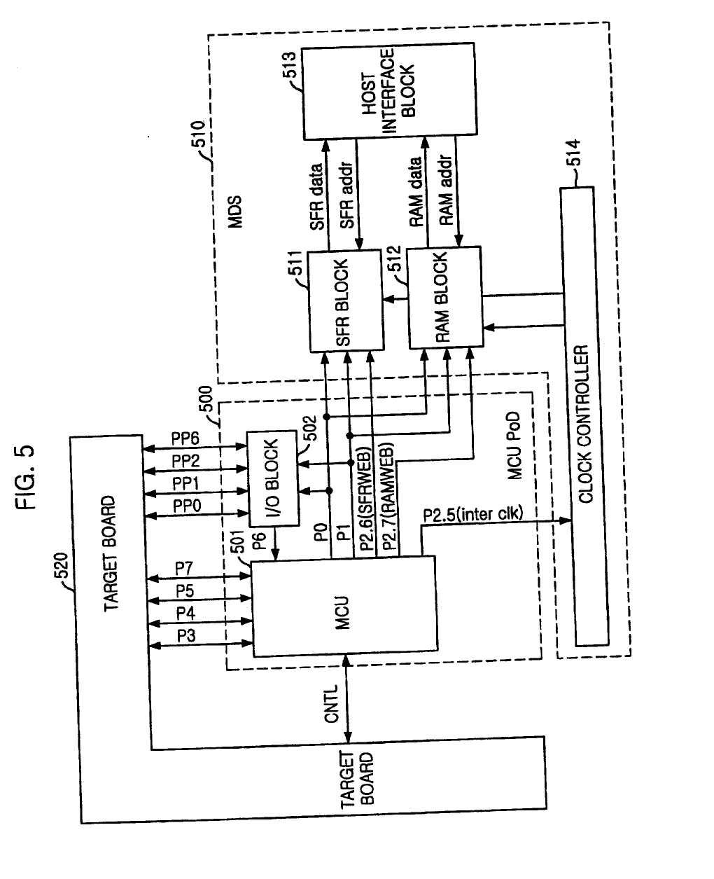

FIG. 5 is a detailed block diagram of an exemplary MDS supporting circuit. However, a virtual ROM, which is shown in FIG. 1, is not shown in FIG. 5 because the configuration of the virtual ROM is the same as that in FIG. 1. Referring to FIG. 5, the illustrated MDS supporting circuit includes an MCU block 500 for communicating port data and control signals CNTL with respect to a target board 520 to be developed by a user through a first set of ports (PP0, PP1, PP2 and PP6) and through a second set of ports (P3, P4, P5 and P7). The MCU block 500 also provides addresses, data and a multiplicity of control signals to an MDS 510 through a multiplicity of ports P0, P1, P2.6 and P2.7. It should be noted that a MCU chip 501 is different form the MCU Eva chip 110 in FIG. 1 in their numbers of pins. That is, the MCU chip 501 is not a specified controls unit adapted for developing programs with additional pins, but a universal control chip not to require additional pins. Each of ports P0, P1, P3, P4, P5, P6 and P7 has 8 pins to process the 8-bit signals, where P2.6 and P2.7 mean 6th and 7 pins of the port 2, respectively.

The MDS supporting circuit also includes the MDS 510 for receiving the address signals and storing data, which are carried out by the MCU chip 501, and storing the data corresponding to the address signals to provide the stored data to a host interface block 513. The SFR write enable signals SFRWEB through P2 and the RAM register write enable signals RAMWEB are respectively inputted into the SFR block 511 and the RAM block 512 and the stored data in the SFR block 511 and the RAM block 512 are provided to a programmer through the host interface block 513. For example, the addresses for accessing the memory or register are transmitted through the port P0 and the data corresponding to the address are transmitted through the port P1. The enable signals SFRWEB and RAMWEB are respectively are transmitted to perform a write operation through the port P2.6 and P2.7. The SFR block 511 and the RAM block 512 are controlled by a clock controller to receive an internal clock from the MCU chip 501.

Accordingly, the SFR block 511 samples the received data to output SFR data to the host interface block 513. The MDS block 510 also includes a RAM block 512 for receiving the RAM address and the data from the MCU block 501 through the ports P0, P1 and P2.7 and for receiving a RAM address RAMaddr from the host interface block 513. The RAM block 512 samples the received data to output RAM data to the host interface block 513. The host interface block 513 of the MDS block 510 receives the SFR data and the RAM data from the SFR block 511 and the RAM block 512, respectively, and outputs address information corresponding to the received data.

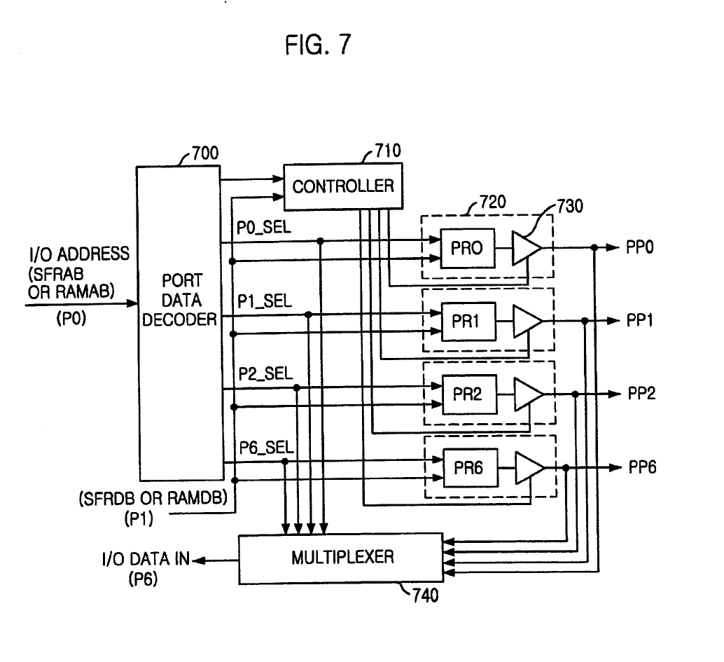

The MDS block 500 also includes an I/O block 502 for receiving the address and the data from the MCU chip 501 through the ports P0 and P1, respectively, and transmits the received data to the target board 520 through te ports PP0, PP1, PP2 and PP6. In the same manner, the MDS block 500 receives the data from the target board 520 through the same ports. These transmissions are controlled by select signals which are produced by a decoder to receive the address signals through the port P0. The detail structure of the MDS block 500 will be described in FIG. 7.

The MCU chip 501 is provided with a multiplicity of MCU I/O ports for inputting/outputting general data and addresses therethrough.

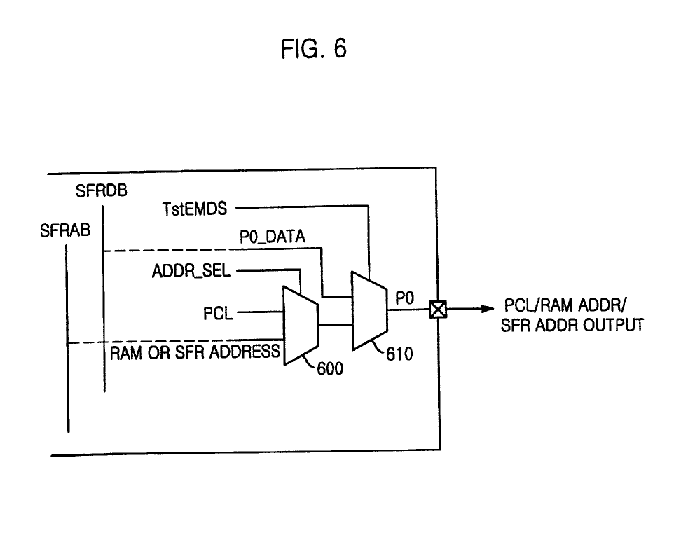

FIG. 6 is a block diagram depicting an exemplary configuration of an MCU I/O port. Referring to FIG. 6, the MCU I/O port includes a first multiplexer 600 controlled by an address selection signal addr_sel and a second multiplexer 610 controlled by an MDS test signal TstEMDS. The first multiplexer 600 receives the RAM address and the SFR address at one input terminal and the program code low address PCL at the other input terminal. The second multiplexer 610 receives the output of the first multiplexer 600 at one input terminal, and the RAM data and the SFR data at the other input terminal (P0_data).

As shown in FIG. 6, the MCU I/O port has a multiplexing structure for timely selecting typical input/output data and MDS supporting data. Data multiplexed by the MCU I/O port includes the program code address and data, the RAM address and data, and the SFR address and data. The multiplexers 600, 610 are controlled by an additional control signal for distinguishing and sampling each data and outputting its multiplexed results to the MDS 510.

FIG. 7 is a detailed block diagram of the I/O block 502 of FIG. 5.

Referring to FIG. 7, the I/O block 502 includes a port data decoder 700 for receiving the I/O address and the SFR address SFRAB. The decoder 700 decodes the received addresses to output the same through each port. The I/O block 502 also includes a controller 710 for receiving an output signal from the port data decoder 700 and the SFR data SFRDB. The controller 710 controls input/output processes in an outputting end. The I/O block 502 also includes a first multiplexer 720 having a three-phase buffer 730 for selecting one of the decoded data signals from the port data decoder 700 and the SFR data SFRDB under the control of the controller 710. Additionally, the data from the target board 520 are directly inputted into a second multiplexer 740 and the second multiplexer 740 selects one of outputs PP0, PP1, PP2 and PP6 and inputs selected data to an internal data bus.

The I/O block 502 receives the I/O data from the MCU chip 501 and transmits the same to a target system to control I/O data to be inputted to the MCU chip 501. Since the I/O port used herein includes internal data for interfacing with the MDS block 510, decoding the SFR data outside of the MCU generates actual I/O data. The generated I/O data is transmitted to the target system, and the I/O data provided to the MCU chip 501 from the target system is fed to the 6th port P6 through the I/O block 500. The I/O data fed to the 6th port P6 is transmitted to a corresponding port according to the I/O address in the MCU chip 501. As a result of, the data from the target board through PP0, PP1, PP2 and PP6 are transmitted to the MCU chip 501 through only one port P6.

The RAM block 512 and the SFR block 511 include a matrix form of register block. The address and the internal data outputted from the MCU chip 501 are stored in a corresponding address of the assigned register block. And then, if an address is inputted from the host interface block 513, the data stored in the corresponding address is outputted. Each data is newly written whenever a data value of the corresponding address is updated. The internal clock is transmitted to the MDS block 510 together with the SFR control signal and the RAM control signal. To achieve such a scheme, four I/O ports are required.

In the following, there is provided Table 1 specifying the function of each port used in the disclosed device to achieve an internal bus to port (IB2P) scheme.

| Mode | P0 | P1 | P2 | P3 | Function |
|---|---|---|---|---|---|
| *Internal | PCL/SFR | PCH/ | 80H/ | ROM | MDS |
| bus to | | SFR Data | *Control | Code/ | Supporting |
| | | | | Portdata | |
| Port | Address | | Signal | Input | Mode + |
| | | | | | External |
| | | | | | Code Fetch |

*Internal bus to port: external code fetch + MDS supporting.
*Control signal: RAM write signal (RAM_WEB), SFR write signal (SFR_WEB), internal clock (inter_clk): RAM and SFR address/data latch signal + internal clock.

As previously mentioned, the illustrated device can effectively support a microprocessor development system by using only a single chip without designing an evaluation chip, to thereby lower a production cost and shorten a development time period.

Although a preferred device has been disclosed for illustrative purposes, those skilled in the art will appreciate that various modifications, additions and substitutions are possible, without departing from the scope and spirit of the invention. There is no intention to limit this patent to the examples disclosed herein. On the contrary, this patent is intended to cover everything falling within the scope of the accompanying claims.

What is claimed is:

1. An apparatus for supporting a microprocessor development system, which comprises:
means for communicating data and control signals with respect to a target board through a multiplicity of ports, and providing a RAM address, a specific function register (SFR) address and data; and
means for receiving the RAM address, the SFR address and the data through the ports, providing the received data to the target board and controlling data to be input to the communicating means.

2. The apparatus as recited in claim 1, wherein the receiving means includes:
a port data decoder for receiving the RAM address or the SFR address and for decoding the received RAM or SFR addresses to develop a first output signal and a plurality of decoded output signals;
a controller for receiving the RAM or SFR data and the first output signal;
a first set of multiplexers for selectively transmitting the RAM or SFR data to the target board through a selected port in response to output signal from the controller and the port data decoder.

3. The apparatus as recited in claim 1, wherein the multiplexer includes:
a three-phase buffer responsive to the controller for outputting a plurality of buffer signals corresponding to the selected ones of the plurality of decoded output signals and the RAM or SFR data; and
a second multiplexer for selecting one of the plurality of data from the target board in response to the port data decoder.

4. The apparatus as recited in claim 1, wherein the communicating means further includes a multiplicity of I/O ports for inputting/outputting general data and address therethrough.

5. The apparatus as recited in claim 4, wherein each of the multiplicity of the I/O ports includes:
a first multiplexer having first and second input terminals and being controlled by an address selection signal, wherein the first multiplexer receives the RAM address or the SFR address at the first input terminal and a program code low address at the second input terminal; and
a second multiplexer having first and second input terminals and being controlled by an MDS test signal, wherein the second multiplexer receives an output of the first multiplexer at the first input terminal and the RAM data or the SFR data at the second input terminal.

6. An apparatus for supporting a microprocessor development system, which comprises:
a target board having a plurality of fictional circuits;
a MUC chip for receiving a program codes and providing the program to the target board;
a plurality of storage blocks connected to an interface through which a programmer check up results of the program;
a decoder for receiving and decoding address signals to access one of the storage blocks;
a multiplexor for selecting one of data transmitted through a plurality of pins in the target board in response to the coded output signals from the decoder.

7. The apparatus as recited in claim 6, wherein the MUC chip has an I/O port including:
a first multiplexer having first and second input terminals and being controlled by an address selection signal, wherein the first multiplexer receives the RAM address or the SFR address at the first input terminal and a program code low address at the second input terminal; and
a second multiplexer having first and second input terminals and being controlled by an MDS test signal, wherein the second multiplexer receives an output of the first multiplexer at the first input terminal and the RAM data or the SFR data at the second input terminal.

8. The apparatus as recited in claim 6, wherein the storage blocks are RAM or register blocks.

9. The apparatus as recited in claim 8, wherein the decoder includes:
a port data decoder for receiving the RAM or register address and for decoding the received RAM or register addresses to develop a first output signal and the decoded output signals;
a controller for receiving the RAM or register data and the first output signal;
a first set of multiplexers for selectively transmitting the RAM or register data to the target board through a selected port in response to output signal from the controller and the port data decoder.
